(19) United States
(12) Patent Application Publication
(10) Pub. No.: US 2018/0354530 A1
(43) Pub. Date: Dec. 13, 2018

(54) SYSTEM AND METHOD FOR THE ANTICIPATORY INFLUENCING OF THE SPEED OF A MOTOR VEHICLE

(71) Applicant: Lucas Automotive GmbH, Koblenz (DE)

(72) Inventor: Christian Freund, Melsbach (DE)

(21) Appl. No.: 15/962,272

(22) Filed: Apr. 25, 2018

(30) Foreign Application Priority Data
May 11, 2017 (DE) 10 2017 004 536.4

(51) Int. Cl. B60W 50/16; B60K 26/02; B60W 30/18; B60W 30/14; G08G 1/0967

(52) U.S. Cl. CPC B60W 50/16; B60K 26/021; B60W 30/181; B60W 2050/0013; G08G 1/096725; B60K 2026/022; B60K 2026/023; B60W 30/146

(57) ABSTRACT

A controller for the anticipatory influencing of the speed of a motor vehicle has the steps: repeatedly determining and evaluating a traffic situation ahead of the host motor vehicle on the roadway currently traveled, as well as the position of the host motor vehicle on the roadway; comparing the determined and evaluated traffic situation to a current driving situation of the host motor vehicle; and determining whether a reduction in the speed of the host motor vehicle, taking into account the determined traffic situation ahead of the host motor vehicle at a distance to be established ahead of the host motor vehicle, in the traffic situation (i) is beneficial to an extent to be established and (ii) is reducible to a target speed to be established, without braking intervention, taking into account the current speed of the host motor vehicle and the distance of the determined traffic situation from the host motor vehicle; and as a function of the determined traffic situation, applying a counterforce to an accelerator pedal against a force applied by the driver, wherein the counterforce is to be dimensioned and/or modulated in the sense of signaling to the driver that he/she is to reduce a force currently applied to the accelerator pedal by the driver.

### BACKGROUND

A system for the anticipatory influencing of the speed of a motor vehicle and a corresponding method are disclosed herein. This system and method are usable in particular to assist the driver in driver-guided motor vehicles. Details in this regard am defined in the claims; in addition, the description and the drawings contain relevant information concerning the system and the operating principle, and also concerning variants of the system and of the method.

### TECHNICAL FIELD

The energy or fuel consumption by motor vehicles in road traffic is influenced to a large degree by how anticipatorily the motor vehicle is operated, i.e., how early that possible external influences on the host driving situation are recognized to allow an appropriate response. Anticipatory driving is characterized, among other things, by the maintenance of an appropriate safety distance. In this way, an earlier response may be made to improper actions by other read users, and, for example, full braking may be avoided when another road user fails to yield right of way to the host motor vehicle. Avoided brake actuations reduce the energy or feel consumption by the host motor vehicle, since reacceleration of the motor vehicle may be eliminated. Likewise, by anticipatory driving, different states of the roadway ahead, or driving on hilly terrain, may be taken into account in a manner that reduces the energy or feel consumption.

### Underlying Problem

Drivers do not always achieve the energy or fuel consumption that is optimal in a driving situation, doe to the fact that their driving style is not sufficiently anticipatory. Thus, for example, as the result of letting up on the accelerator pedal (gas pedal) too late for speed reduction, the speed of the host vehicle is still too high in a specific driving situation. Therefore, the driver must also actuate the brake pedal immediately after letting up on the accelerator pedal in order to reach the desired or appropriate vehicle speed. Such driving behavior results in increased energy or fuel consumption.

### Proposed Solution

A system/a method for the anticipatory influencing of the speed of a motor vehicle assists the driver of the host motor vehicle in driving the host motor vehicle in a more anticipatory manner, and, by use of suitable measures, in avoiding full braking and taking into account different states of the roadway ahead, or driving on hilly terrain, etc.

This system and method for the anticipatory influencing of the speed of the motor vehicle is based on a surroundings sensor system of the host motor vehicle and/or on (geographical/road) maps, combined with a current position determination of the host motor vehicle. The surroundings sensor system of the host motor vehicle may be based on radar, lidar, (daylight or infrared) cameras, ultrasound, or the like, and/or on map material that may be combined with a current position determination of the host motor vehicle. A satellite-based navigation device, for example, may provide this position determination. The surroundings sensor system and/or the position determination is/are configured for determining the course of the roadway currently traveled, as well as the position of the host motor vehicle on the roadway. A brake pedal may be provided in the system of the motor vehicle, and is configured for a deceleration intent, for decelerating the host motor vehicle, being applied to it by the driver as a brake force. In addition, an accelerator pedal is provided in the system of the motor vehicle, and is configured tor a speed intent, for increasing the speed of the host vehicle, being applied to it by the driver as a force. Associated with this accelerator pedal is an actuator which is configured for a counterforce, opposite the force, being applied to the accelerator pedal by the driver in a targeted manner. A controller of the system of the host motor vehicle provides an extent of this counterforce. This controller is provided and configured for repeatedly determining and evaluating the traffic situation ahead of the host motor vehicle and comparing it to a current driving situation of the host motor vehicle. In addition, the controller is provided and configured for determining whether a reduction in the speed of the host motor vehicle, taking into account the determined traffic situation ahead of the host motor vehicle at a distance to be established ahead of the host motor vehicle, in the traffic situation (i) is beneficial to an extent to be established and (ii) is to be reduced to a target speed to be established, without braking intervention, taking into account the current speed of the host motor vehicle and the distance of the determined traffic situation from the host motor vehicles and as a function of the determined traffic situation, for applying a counterforce to the accelerator pedal, which is to be dimensioned and/or modulated in the sense of signaling to the driver that he/she is to reduce a force currently applied to the accelerator pedal by the driver.

The distance to be established ahead of the host motor vehicle, in which the traffic situation is determined, may vary as a function of the current speed of the host motor vehicle. Likewise, the frequency with which the traffic situation ahead of the host motor vehicle is determined and evaluated may vary as a function of the current speed of the host motor vehicle. Factors of the current driving situation of the host motor vehicle may be the speed of the host motor vehicle, the uphill grade/downhill grade of the roadway currently traveled, the loading state of the host motor vehicle, the friction conditions of the roadway currently traveled, or the like. The extent, to be established, of the benefit of a reduction in the speed of the host motor vehicle may be a function of the determined traffic situation such that, for example, a particularly critical traffic situation (such as restricted entry at a railway crossing) ahead of the host motor vehicle requires a particularly high extent, while a less critical traffic situation (such as a curve of the roadway having a large radius of curvature) ahead of the host motor vehicle requires only a small extent.

As a function of the determined traffic situation, a counterforce is applied to the accelerator pedal which is to be dimensioned and/or modulated in the sense of signaling to the driver. As a result of this counterforce, the driver is to be informed that he/she should now let up on the accelerator pedal in order to initiate a reduction in the speed of the host motor vehicle.

This system is capable of actively communicating with the driver and assisting the driver with his/her driving habits in an anticipatory and energy-efficient manner in terms of traffic safety. By means of such an “active” accelerator pedal, the driver receives haptic feedback for the anticipatory driving mode with regard to the traffic situation ahead of the host motor vehicle. For this purpose, the active accelerator pedal has an actuator that applies an additional counterforce to the accelerator pedal in a targeted manner. For example, beginning with a certain driver intent, the actuator, which corresponds to a predetermined accelerator pedal position, may generate a variably settable pressure point via which further depression of the accelerator pedal is made more difficult, but which may be overcome by the driver.

Thus, a motor vehicle is known from DE 10 2012 217 677 A1, in which the gas pedal is an active accelerator pedal that may be acted on with an additional counterforce, with formation of such a pressure point with an actuator that is controllable by a control unit.

### Further Embodiments and Advantageous Refinements

In one variant, the control system is configured and intended for the actuator on the accelerator pedal to apply the signaling to the driver as a counterforce to the accelerator pedal in the form of vibration, knocking, or as an increasing force.

In another variant, the controller is configured and intended for changing the duration and/or intensity of the signaling to the driver in such a way that the signaling represents an extent of an actuation of the accelerator pedal to be reduced by the driver.

In another variant, the controller is configured and intended for determining the traffic situation ahead of the host vehicle with regard to traffic signs, traffic lights, ends of traffic jams, uphill grades, downhill grades, and narrowing roadways, based on the surroundings sensor system of the host vehicle, the maps, and/or the current position determination of the host vehicle.

In another variant the controller is configured and intended for not taking into account a current speed intent of the driver if the force currently applied to the accelerator pedal by the driver is not, or is not sufficiently, reduced for reaching the target speed, and causing the target speed of the vehicle to be reached, regardless of the speed intent of the driver, by signaling to a drive controller of the vehicle.

In another variant, the actuator is designed as an electromagnet that is coupled to the accelerator pedal of the vehicle by gearing.

A corresponding control method for the anticipatory influencing of the speed of a motor vehicle has the following steps:

repeatedly determining and evaluating a traffic situation ahead of the host motor vehicle on the roadway currently traveled, as well as the position of the host motor vehicle on the roadway;

comparing the determined and evaluated traffic situation to a current driving situation of the host motor vehicle; and

determining whether a reduction in the speed of the host motor vehicle, faking into account the determined traffic situation ahead of the host motor vehicle at a distance to be established ahead of the host motor vehicle, in the traffic situation (i) is beneficial to an extent to be established and (ii) is reducible to a target speed to be established, without braking intervention, taking into account the current speed of the host motor vehicle end the distance of the determined traffic situation from the host motor vehicle; and

as a function of the determined traffic situation, applying a counterforce to an accelerator pedal against a force applied by the driver, wherein the counterforce is to be dimensioned and/or modulated in the sense of signaling to the driver that he/she is to reduce a force currently applied to the accelerator pedal by the driver.

### BRIEF DESCRIPTION OF THE DRAWINGS

Further aims, features, advantages, and possible applications result from the following description of exemplary embodiments, which are not to be construed as limiting, with reference to the associated drawings. All features described and/or graphically illustrated, alone or in any combination, constitute the subject matter disclosed herein, also independently of their grouping in the claims or their back-references. The dimensions and proportions of the components shown in the figures are not necessarily to scale, and in the embodiments to be implemented may differ from those illustrated herein, wherein

FIG. 1 is a schematic view of a control system for a vehicle constructed in accordance with the present invention; and

FIG. 2 is a schematic illustration of a vehicle being operated in a traffic situation.

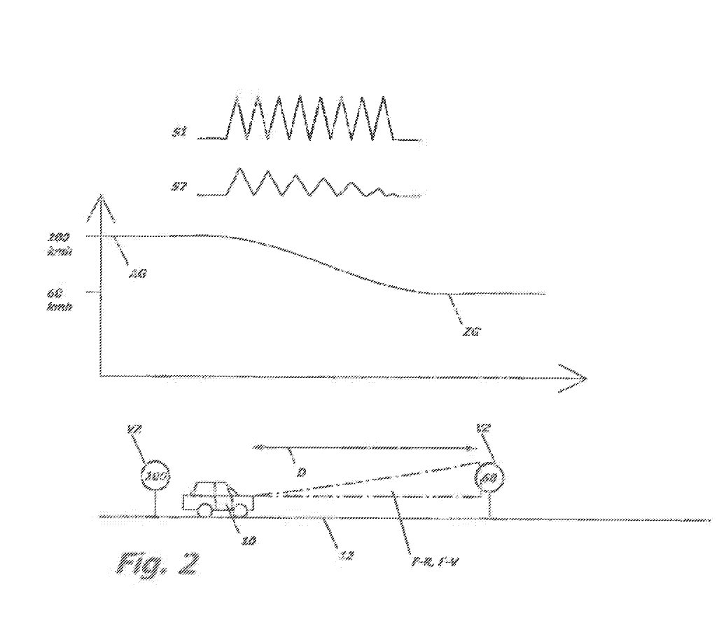

### DETAILED DESCRIPTION OF THE DRAWINGS

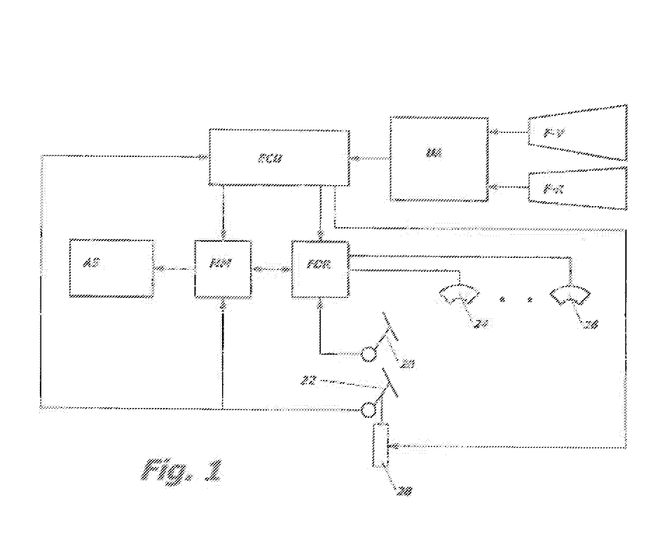

FIG. 1 schematically shows a driving situation in which a host (motor) vehicle 10 is traveling on a straight roadway segment 12. A control system ECU associated with the vehicle is used for the anticipatory influencing of the speed of the motor vehicle. This control system ECU accesses a surroundings sensor system of the host vehicle and road maps, combined with a current position determination from a satellite-based navigation device, for example. In one variant not further depicted here, the surroundings sensor system includes radar sensors and (infrared and daylight) (video) cameras with which the surroundings situation in front of and to the sides of the vehicle 10 is detected and evaluated. By use of this surroundings sensor system and the position determination, the course of the roadway currently traveled and the position of the host vehicle on the roadway are determined and continuously provided to the control system ECU. The control system ECU includes a computer, program/data memories, input/output devices, etc, (not illustrated in greater detail).

A brake pedal 20 may be provided in the system of the motor vehicle 10, to which the driver may apply a deceleration intent, as a brake force, for decelerating the host motor vehicle 10. This deceleration intent of the driver is detected by the brake pedal 20, and in a vehicle dynamics controller FDR, together with other data from the vehicle operation, is converted to corresponding control signals for wheel brakes 24-26 of the motor vehicle 10 in order to reduce the rotational speed of wheels of the motor vehicle 10, not depicted in greater detail.

In addition, an accelerator pedal 22 is provided in the system of the motor vehicle 10, to which the driver may apply a speed intent, as a force, for increasing the speed of the host vehicle. Associated with this accelerator pedal 22 is an actuator 28 for applying a counterforce to the accelerator pedal 22, opposite the force applied by the driver, in a targeted manner. The controller ECU of the system of the host motor vehicle 10 provides an extent of this counterforce via corresponding control signals for the actuator 28. In the variant illustrated: the actuator 28 is designed as an electromagnet that is coupled to the accelerator pedal of the vehicle by gearing.

The controller ECU, explained in greater detail below, in the control system repeatedly determines the traffic situation ahead of the host motor vehicle 10 and evaluates it by means of a surroundings evaluation unit UA. The surroundings evaluation unit UA is configured for recognizing traffic signs VZ, recognizing route information (course of the roadway, uphill grades, downhill grades, etc.), traffic lights, narrowing roadways, or traffic jam situations from cloud applications (Google maps, for example), recognizing persons present on the roadway via radar/image evaluations, and comparing same to a current driving situation of the host motor vehicle 10. Factors of the current driving situation of the host motor vehicle 10 are the speed of the host motor vehicle 10, the uphill grade/downhill grade of the roadway 12 currently traveled, the loading state of the host motor vehicle 10, the friction conditions of the roadway 12 currently traveled, or the like.

For implementing the anticipatory driving and the anticipatory influencing of the speed, the control system ECU determines whether a reduction in the speed of the host motor vehicle 10, taking into account the determined traffic situation ahead of the host motor vehicle 10 at a distance to be established ahead of the host motor vehicle 10, in the traffic situation is beneficial to an extent to be established and is to be reduced from a current speed AG to a target speed ZG to be established, taking into account the current speed AG of the host motor vehicle 10 and the distance D of the determined traffic situation from the host motor vehicle 10, without braking intervention.

The distance A, to be established in the controller ECU, ahead of the host motor vehicle, in which the traffic situation is determined varies as a function of the current speed of the host motor vehicle, the detection range of the surroundings sensor system F-R, F-V, the visibility conditions, etc. In addition, the frequency with which the traffic situation ahead of the host motor vehicle 10 is determined and evaluated varies as a function of the current speed of the host motor vehicle 10. A fairly low evaluation frequency may be sufficient at lower speed. The extent of the benefit of reducing the speed of the host motor vehicle, to be determined in the controller ECU, is a function of the determined traffic situation such that, for example, a particularly critical traffic situation ahead of the host motor vehicle requires a particularly high extent, while a less critical traffic situation ahead of the host motor vehicle requires only a small extent. Therefore, the figure illustrates by way of example a speed reduction indicated by a traffic sign VZ, which represents a moderate extent of the benefit of reducing the speed.

The controller ECU, explained in greater detail below, in the control system repeatedly determines the traffic situation ahead of the host motor vehicle 10 and evaluates it by means of a surroundings evaluation unit UA. The surroundings evaluation unit UA is configured for recognizing traffic signs VZ, recognizing route information (course of the roadway, uphill grades, downhill grades, etc.), traffic lights, narrowing roadways, or traffic jam situations from cloud applications (Google maps, for example), recognizing persons present on the roadway via radar/image evaluations, and comparing same to a current driving situation of the host motor vehicle 10. Factors of the current driving situation of the host motor vehicle 10 are the speed of the host motor vehicle 10, the uphill grade/downhill grade of the roadway 12 currently traveled, the loading state of the host motor vehicle 10, the friction conditions of the roadway 12 currently traveled, or the like.

For implementing the anticipatory driving and the anticipatory influencing of the speed, the control system ECU determines whether a reduction in the speed of the host motor vehicle 10, taking into account the determined traffic situation ahead of the host motor vehicle 10 at a distance to be established ahead of the host motor vehicle 10, in the traffic situation is beneficial to an extent to be established and is to be reduced from a current speed AG to a target speed ZG to be established, taking into account the current speed AG of the host motor vehicle 10 and the distance D of the determined traffic situation from the host motor vehicle 10, without braking intervention.

When the controller ECU now determines, taking into account the determined traffic situation ahead of the host motor vehicle 10, the current speed AG of the host motor vehicle 10, and the distance D of the determined traffic situation ahead of the host motor vehicle 10, that it is possible to reduce the vehicle speed from a current speed AG to the target speed ZG to be established, without braking intervention, the actuator 28 is acted on by signals S1 or S2 in such a way that it applies a counterforce to the accelerator pedal 22. This counterforce applied to the accelerator pedal 22 is dimensioned and modulated in such a way that the driver understands it as an instruction to reduce the force that he/she is currently applying to the accelerator pedal 22. Letting up on the accelerator pedal 22 is intended to reduce the speed of the host motor vehicle without the need for actuating the brake pedal. The actuator 28 applies the signaling S1, S2 to the accelerator pedal 22 to the driver in the form of vibration, knocking, or as an increasing force.

A current (angular) position of the accelerator pedal 22 is transmitted to a motor management unit MM of the motor vehicle 10, which from this information (and from other factors) generates a control signal, for example a throttle valve setting signal of an internal combustion engine, for the drive train AS of the motor vehicle 10.

If the driver does not let up on the accelerator pedal 22, despite the counterforce applied by the actuator 28, this is signaled to the controller ECU by the accelerator pedal 22. For the case that the force currently applied to the accelerator pedal by the driver is not, or is not sufficiently, reduced to reach the target speed, the controller ECU is configured for not taking into account a current speed intent of the driver, and by signaling to a drive controller (motor management unit, drive train MM, AS) of the vehicle 10, and causing the target speed ZG of the vehicle 10 to be reached, regardless of the intent of the driver. In other words, the speed intent of the driver on the accelerator pedal 22 is ignored, and the controller ECU cancels/suppresses the effectiveness of the speed intent of the driver until the target speed ZG is reached.

The variants described above as well as their design and operational aspects are used solely for better understanding of the structure, the operating principle, and the properties; they do not limit the disclosure to the exemplary embodiments, for example. The figures are sometimes schematic, and important properties and effects are sometimes illustrated in much larger scale, in order to clarify the functions, functional principles, technical embodiments, and features. Any operating principle, any principle, any technical embodiment, and any feature that is disclosed in the figures or in the text, together with all claims, may be freely and arbitrarily combined with any feature in the text and with the other figures, other operating principles, principles, technical embodiments, and features that are contained in the present disclosure or that result therefrom, so that all conceivable combinations of the described variants are to be assigned. Also encompassed are combinations between all individual statements in the text, i.e., in any section of the description, in the claims, as wall as combinations between various variants in the text, in the claims, and in the figures. Furthermore, the claims do not limit the disclosure, or thus, the combination options of all disclosed features with one another. All disclosed features are also explicitly disclosed herein, individually and in combination with all other features.

1. A control system for the anticipatory influencing of the speed, based on a surroundings sensor system of a host motor vehicle and/or on maps, combined with a current position determination, wherein
the surroundings sensor system and/or the position determination is/are configured for determining the traffic situation ahead of the host motor vehicle on the roadway currently traveled, as well as the position of the host motor vehicle on the roadway;
an accelerator pedal is provided that is configured for a speed intent, for increasing the speed of the host vehicle, being applied to it by the driver as a force;
the accelerator pedal has an actuator that is configured for a counterforce, opposite the force, being applied to the accelerator pedal by the driver in a targeted manner;
a controller is provided and configured for:
repeatedly determining and evaluating the traffic situation ahead of the host motor vehicle and comparing it to a current driving situation of the host motor vehicle; and
determining whether a reduction in the speed of the host motor vehicle, taking into account the determined traffic situation ahead of the host motor vehicle at a distance to be established ahead of the host motor vehicle, in the traffic situation (i) is beneficial to an extent to be established and (ii) is reducible to a target speed to be established, without braking intervention, taking into account the current speed of the host motor vehicle and the distance of the determined traffic situation from the host motor vehicle; and
as a function of the determination, applying a counterforce to the accelerator pedal which is to be dimensioned and/or modulated in the sense of signaling to the driver that he/she is to reduce a force currently applied to the accelerator pedal by the driver.

2. The control system for the anticipatory influencing of the speed according to claim 1, wherein the actuator on the accelerator pedal applies the signaling to the accelerator pedal to the driver in the form of vibration, knocking, or as an increasing force.

3. The control system for the anticipatory influencing of the speed according to claim 1, wherein the controller changes the duration and/or intensity of the signaling to the driver in such a way that the signaling represents an extent of an actuation of the accelerator pedal to be reduced by the driver.

4. The control system for the anticipatory influencing of the speed according to claim 1, wherein the controller is configured for determining the traffic situation ahead of the host vehicle with regard to traffic signs, traffic lights, ends of traffic jams, uphill grades, downhill grades, and narrowing roadways, based on the surroundings sensor system of a host vehicle, the maps, and/or the current position determination of the host vehicle.

5. The control system for the anticipatory influencing of the speed according to claim 1, wherein the controller is configured for not taking into account a current speed intent of the driver if the force currently applied to the accelerator pedal by the driver is not, or is not sufficiently, reduced for reaching the target speed, and causing the target speed of the vehicle to be reached, regardless of the speed intent of the driver, by signaling to a drive controller of the vehicle.

6. The control system for the anticipatory influencing of the speed according to claim 1, wherein the actuator is designed as an electromagnet that is coupled to the accelerator pedal of the vehicle by gearing.

7. A control method for the anticipatory influencing of the speed of a motor vehicle, having the steps:
repeatedly determining and evaluating a traffic situation ahead of the host motor vehicle on the roadway currently traveled, as well as the position of the host motor vehicle on the roadway;
comparing the determined and evaluated traffic situation to a current driving situation of the host motor vehicle, and
determining whether a reduction in the speed of the host motor vehicle, taking into account the determined traffic situation ahead of the host motor vehicle at a distance to be established ahead of the host motor vehicle, in the traffic situation (i) is beneficial to an extent to be established and (ii) is reducible to a target speed to be established, without braking intervention, taking into account the current speed of the host motor vehicle and the distance of the determined traffic situation from the host motor vehicle; and
as a function of the determined traffic situation, applying a counterforce to an accelerator pedal against a force applied by the driver, wherein the counterforce is to be dimensioned and/or modulated in the sense of signaling to the driver that he/she is to reduce a force currently applied by the driver to the accelerator pedal.
